(19) United States
(12) Patent Application Publication
(10) Pub. No.: US 2019/0384556 A1
(43) Pub. Date: Dec. 19, 2019

(54) LIGHT-EMITTING CLOTHING TRIMMINGS

(71) Applicant: AVERY DENNISON RETAIL INFORMATION SERVICES, LLC, Mentor, OH (US)

(72) Inventors: Mathieu DE BACKER, Grottammare (AP) (IT); Alberto MORELLI, San Benedetto del Tronto (AP) (IT)

(21) Appl. No.: 16/443,045

(22) Filed: Jun. 17, 2019

Related U.S. Application Data
(60) Provisional application No. 62/685,503, filed on Jun. 15, 2018.

(51) Int. Cl. G06F 3/14; G09G 3/32; G09G 3/3208; H04M 1/725; A41D 27/08; A41D 13/01

(52) U.S. Cl. CPC G06F 3/14; G09G 3/32; G09G 3/3208; H04M 1/7253; H04M 2201/38; A41D 13/01; G09G 2330/021; G09G 2354/00; G09G 2380/02; A41D 27/085

(57) ABSTRACT

A light-emitting trimming, particularly a light-emitting trimming for an article of clothing, which may be configured to provide light or to provide messages on a display screen. Such a trimming may be integrated into a high-visibility safety vest or other article of clothing in order to provide additional visibility to the article, enhancing its effects for the wearer and promoting safety. Such a trimming may also be integrated into any article in order to provide displayed messages, which can be controlled by a controller such as a smartphone and may be as simple or complex as desired. The trimming may be applied in the form of a tape, label, insert, or other article, and may be applied to an article of clothing in such a manner that the complete construction is washable.

### CROSS REFERENCE TO RELATED APPLICATION(S)

The present application claims priority to and the benefit of U.S. provisional utility patent application No. 62/685,503 filed Jun. 15, 2018, which is incorporated herein by reference in its entirety.

### BACKGROUND

High-visibility clothing, or HV clothing, is a type of personal protective equipment (PPE) usually worn for safety reasons. A variety of options for HV clothing exist, but by far the most common form that HV clothing takes is the semi-ubiquitous reflective vest. These vests are often fluorescent green or orange in color and are fitted with a set of retroreflective strips extending across the vest.

HV clothing is most typically worn by workers or other parties who expect to be operating in dangerous or low-visibility areas. For example, HV clothing is often worn by railway and highway workers, airport workers, any other workers who might be operating near moving vehicles or in any kind of dark areas (such as security or maintenance personnel in parking garages), as well as any other parties who might be operating in or near traffic such as cyclists or emergency services personnel. HV clothing is also sometimes worn in other circumstances, such as by hunters, military personnel, or range safety officers in order to prevent accidental shooting.

Options to retrofit clothing, articles, or vehicles with high-visibility or retroreflective materials also exist. For example, numerous varieties of reflective tape, reflective helmets, reflective backpacks, reflective bicycle parts, and other similar articles exist and serve to promote increased visibility for cyclists, motorcyclists, and other riders. Some cars (such as police vehicles or other emergency vehicles) are also fitted with reflective decals or reflective materials.

Safety experts have found that high-visibility clothing and high-visibility materials sharply reduce many kinds of accidents or dangers when properly worn or applied. For example, several studies have shown that the population attributable risk of wearing no reflective clothing for a bicyclist or motorcyclist in traffic is between 33% and 50%; that is, between a third and half of all bicycle and motorcycle accidents could have been prevented had the cyclist been wearing high-visibility clothing. Similar results have been shown for hunters. As a result, many jurisdictions require cyclists or hunters to wear high-visibility clothing, and others strongly encourage it.

However, one major downside with high-visibility clothing as it currently exists is that all high-visibility clothing, regardless of its reflective attributes, must be illuminated in order to be effective. In some environments, sources of illumination are plentiful, and this is less of an issue; for example, cyclists in an urban environment can often count on being illuminated by streetlights, or by the headlights of vehicles moving at lower speeds (or ambient light from headlights of nearby vehicles). However, this is much more of an issue in rural areas or other areas where sources of illumination are less plentiful and there is less light to reflect. For example, this can mean that a hunter in dim woods is not nearly as visible as they should be, or can mean that a cyclist traveling after dark cannot be clearly discerned until a speeding vehicle is almost upon them. It can also mean that a cyclist cannot easily be distinguished from an inanimate object including a reflective material. For example, a driver might confuse a cyclist with a safety barrier or traffic cone. As such, many cyclists recommend installing lights and even noisemakers on their vehicle in order to enhance their visibility. This, however, is not always an option for other wearers of high-visibility gear, such as emergency personnel, road workers, and the like, who will commonly be on foot and away from any illuminated vehicle.

Another problem with high-visibility clothing, in some instances, is that it may draw excess attention to the wearers. While for many wearers it may be desirable to draw as much attention to themselves as possible—cyclists, for example, are generally very interested in making sure drivers see them, and will do everything they can to ensure that—some wearers may want to manage the attention they receive. For example, if emergency personnel are stopped at the side of the road and need to manage traffic, it may be important to ensure that drivers do not stop and gawk, and if emergency personnel are managing traffic outflow from a concert or sporting event, it may be important to ensure that drivers realize that police are on-site for this purpose rather than because of some security incident, and may be important to ensure that drivers are conducted to the right places. Doing either typically requires voice amplification technology, like megaphones, whereby an officer can repeatedly provide a set of instructions to traffic, which has its own set of problems.

Aside from the safety aspects of high-visibility clothing, there are also fashion aspects to high-visibility clothing. Workwear-inspired clothing, particularly high-visibility-gear-inspired clothing, was one of 2017's biggest trends at fashion shows, and many clothing lines took inspiration from working outfits, such as the full high-visibility gear favored by builders and sanitation workers to sturdy overalls and work pants worn by laborers across the world. This trend ramped up in 2018, with CALVIN KLEIN®, CHALAYAN®, MAISON MARGIELA® and TIBI® all showing off hi-visibility jackets in bold and bright orange colors, complete with reflective detailing designed to invoke aspects of a building site. Numerous reasons exist for this. Perhaps the most important one is that a new generation of young, discriminating, and typically city-dwelling consumers has developed a taste for the sturdy, utilitarian style of workwear from decades past, due to efforts by historically blue-collar brands (such as CARHART®) to market to these consumers thanks to the decline in blue-collar manufacturing jobs. Many note that “workwear is symbolic of quality” in the consumer's mind. Another important reason is that fashion has always been about attracting attention, something that high-visibility clothing is obviously designed to do.

However, actually selling this aesthetic has been somewhat tricky. The most typical new consumers of workwear clothing have tended to reject the flashy aesthetics of fast-fashion chains, and many of the designs from fashion runway shows—intended to be eye-catching all the time—have been criticized as overdoing the “fashionable workwear” aesthetic. Thus there is a strong market for products which can evoke the workwear aesthetic for quality reasons, which can still be eye-catching, but which are not garish and which do not rely on flashy aesthetics. There has also been a strong market for clothing for less fashion-minded consumers who still have self-expression on the mind, and who typically have been more willing to chase novelty for its own sake.

### SUMMARY

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present disclosure, a light-emitting apparatus comprises a trimming configured to be attached to an article, a light-emitting material, and a power source for powering the light-emitting material. In some embodiments, the trimming can be a tape, a label, or an insert. Where the trimming is a tape, the tape can be a woven tape, a polyurethane tape, a silicone tape, or any other suitable tape known to those of skill in the art. In some embodiments, the trimming is configured to be stitched to an article, such as an apparel item. The apparatus may further include an edge portion disposed along at least one edge of the trimming. In some embodiments, the edge portion is configured to facilitate stitching the trimming to an article, such as an apparel item. In some embodiments, the trimming is configured to be applied to an article, such as an apparel item, using heat and/or pressure. For example, the apparatus may further comprise an adhesive backing disposed along at least a portion of a back side of the trimming to facilitate applied the trimming to an article using heat and/or pressure.

In some embodiments of the present disclosure, the light-emitting material comprises one or more threads of light-emitting material. In some embodiments, the light-emitting material comprises a tape of light-emitting material. In some embodiments, the light-emitting material comprises one or more light-emitting diodes and/or one or more organic light-emitting diodes.

According to some embodiments, the light-emitting apparatus has a direct power source. For example, a direct power source may be a battery. In some embodiments, the battery may be flexible and/or washable. In other embodiments, the light-emitting apparatus has an indirect power source. For example, the indirect power source may comprise radio-frequency identification (RFID) technology configured to transmit power to the light-emitting material. In some embodiments, the RFID technology comprises near-field communication technology.

In some embodiments of the present disclosure, the light-emitting apparatus comprises a controller configured to populate one or more images on the light-emitting apparatus. For example, the one or more images may be one or more alphanumeric characters. In such embodiments, messages can be populated on the light-emitting apparatus. In some embodiments, the controller is further configured to connect the light-emitting apparatus to a control device so that a user can select one or more images to be populated on the light-emitting apparatus.

According to other aspects of the present disclosure, a system for a light-emitting apparatus is provided. The system may comprise a trimming, a light-emitting material, a power source for powering the light-emitting material, a controller coupled to the power source and containing control logic capable of controlling the light-emitting material to emit light and/or populate one or more images on the light-emitting apparatus, and a control device capable of coupling with the controller and having an application configured to allow a user to select a light to be emitted or the one or more images to be populated on the light-emitting apparatus.

According to other aspects of the present disclosure, a method for populating one or more images on a light-emitting apparatus comprises opening an application on a smartphone, pairing the smartphone with a controller of a light-emitting trimming attached to an article, selecting one or more images, via the application, to be populated on the light-emitting trimming. In some embodiments, the method includes programming, via the application, the controller to populate an updated image on the light-emitting trimming at a specified time.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE FIGURES

Advantages of embodiments of the present disclosure will be apparent from the following detailed description of the exemplary embodiments thereof, which description should be considered in conjunction with the accompanying drawings in which like numerals indicate like elements, and in which:

FIG. 1 depicts a high-visibility vest such as may exist in the prior art.

FIG. 2 depicts a consumer article of clothing equipped with reflective material, such as may exist in the prior art.

FIG. 3 depicts a roll of extensible fabric barrier material such as may exist in the prior art.

FIG. 4 depicts a light-emitting trimming according to one embodiment of the present disclosure.

FIG. 5 depicts a light-emitting trimming for messaging according to one embodiment of the present disclosure.

FIG. 6 depicts a high-visibility vest as provided with a light-emitting trimming according to one embodiment of the present disclosure.

FIG. 7 depicts a consumer article of clothing equipped with a light-emitting trimming according to one embodiment of the present disclosure.

FIG. 8 depicts a roll of extensible fabric barrier material equipped with a light-emitting trimming according to one embodiment of the present disclosure.

FIG. 9 depicts a digital flexible display screen such as may exist in the prior art.

FIG. 10 is an exemplary flowchart providing an exemplary embodiment of a method of using a light-emitting trimming.

FIG. 11 depicts a flowchart providing an alternate embodiment of a method of using a light-emitting trimming.

FIG. 12 depicts a system for displaying a message on light-emitting trimming according to one embodiment of the present disclosure.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

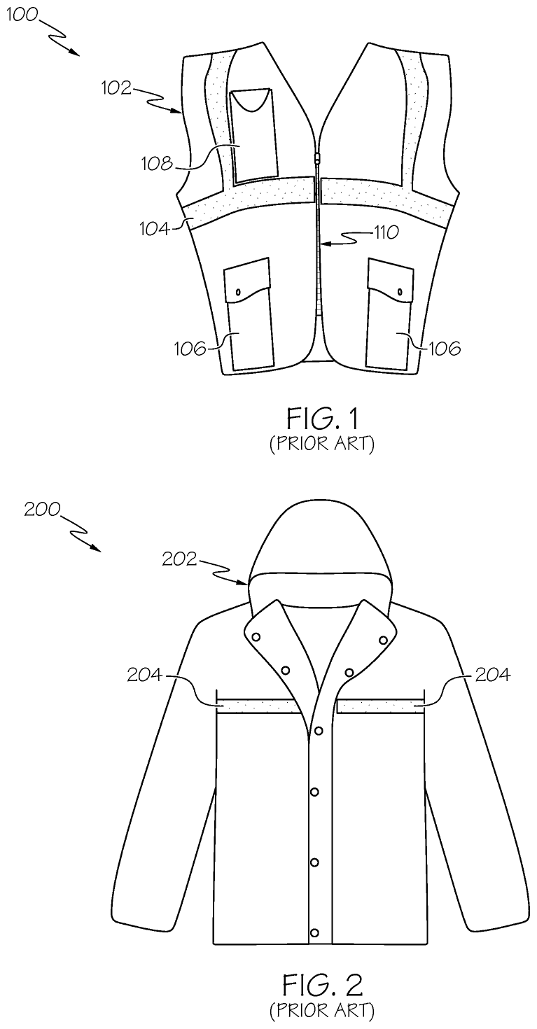

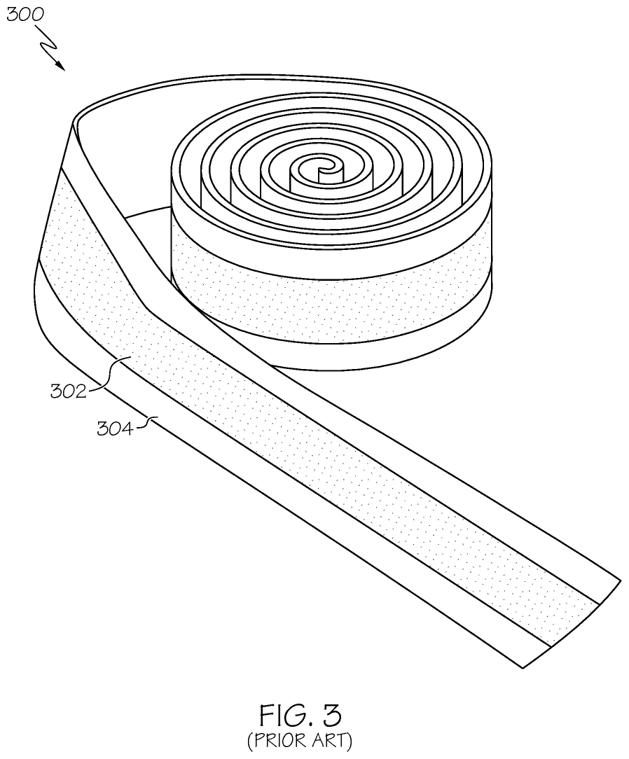

With reference to exemplary FIGS. 1-3, FIGS. 1-3 display exemplary embodiments of reflective or fabric articles known in the prior art. Specifically, FIG. 1 depicts a reflective vest 100 such as may exist in the prior art, FIG. 2 depicts a reflector-fitted article of clothing 200 (in particular a jacket) such as may exist in the prior art, and FIG. 3 depicts a fabric barrier 300 such as may exist in the prior art.

Looking first at FIG. 1, an exemplary embodiment of a reflective vest 100 may be formed from fluorescent fabric 102, and may have one or more reflective strips 104 disposed thereupon. The vest 100 may have one or more pockets 106, one or more ID badge holders 108, and any other features or embellishments known in the art. In an exemplary embodiment, the vest 100 may be linked in the front by a closure 110, such as a zipper.

Looking next at FIG. 2, an exemplary embodiment of a reflector-fitted article of clothing 200 includes consumer article 202, such as a jacket. The consumer article 202 may be fitted with one or more reflectors 204, which may, for example, come in the form of reflective tape. According to an exemplary embodiment, reflectors 204 may enhance visibility of the user by others when the user is wearing the reflector-fitted article of clothing 200, such as when they are on a bicycle at night or in other low-light conditions.

Looking next at FIG. 3, an exemplary embodiment of a fabric barrier 300 may be provided, with a structural portion 304 and a reflective portion 302. Fabric barrier 300 may be used for crowd control or for other purposes such as may be desired, and may be rolled and unrolled or otherwise extended and retracted such as may be desired.

According to an exemplary embodiment, and referring generally to the Figures, various exemplary implementations of a light-emitting trimming, including light-emitting trimming which may be fitted to various items of apparel and clothing, may be disclosed. In some exemplary embodiments, this light may take the form of a message, such as a message displayed on a screen, as desired.

In some embodiments, a light-emitting clothing trimmings arrangement, and a method of using the same, may each be disclosed. As noted, the vast majority of safety products currently in the market are based on reflective technology, whereby the safety product is configured to reflect back a light source so as to ensure that the safety product is visible. In order to be seen in the dark, then, a light source must strike the safety product and be reflected. Moreover, the light source must strike the safety product at a particular angle in order to be reflected back. In contrast, the present arrangement may advantageously provide a safety product with its own light source such that the object will be highly visible from all angles. In some embodiments, a present arrangement of the light-emitting safety product further includes one or more reflective trimmings as is known in the art to further enhance visibility of the light-emitting safety product.

According to an exemplary embodiment, a light-emitting apparatus, such as a light-emitting trimmings arrangement, may be provided. The light-emitting apparatus can be provided on an object. In some embodiments, the light-emitting apparatus may include an active light-emitting tape or trim that allows the object to be visible from all angles. In some embodiments, the light-emitting tape or trim may be connected to a power source, which may be, for example, a flexible and/or washable battery. In other embodiments, the power source may be or may include radio-frequency identification (RFID) technology, including near-field communication (NFC) technology, that can transmit power to the light-emitting tape or trim.

In an exemplary embodiment, a light-emitting apparatus may be or may include a tape, label, or insert with an active light source. In some embodiments, the active light source may be configured to constantly emit light or to intermittently emit light according to pre-recorded or user-specified frequencies or patterns. in some embodiments, the active light source may be or may include a light emitting material such as a yarn, coating, or finish, which may be coupled to a power source and integrated into a tape, badge, or fabric component. In some exemplary embodiments, the tape, badge, or fabric component may be applied to a garment or other item using heat and/or pressure, or may be stitched to the garment or other item. In some exemplary embodiments, the end result may be washable.

In an exemplary embodiment, multiple different configurations of a light-emitting apparatus are contemplated. For example, a light-emitting apparatus may comprise parallel strips of a light-emitting material, such as a light-emitting tape. In some embodiments, each strip may provide a different color of light, or all strips may provide the same color of light. In some embodiments, one or more strips may provide alternating colors of lights. In some embodiments, a light-emitting apparatus may have different light-emitting yarns, coatings, or finishes, each of which may be configured to generate light in a different color and/or different intensity. This may allow the resulting emitted light, or the intensity of the resulting emitted light, to be easily varied.

For example, a light-emitting apparatus may be configured to provide light in at least a low intensity and a high intensity, in order to provide lower power consumption when necessary or higher visibility when necessary. In some embodiments, a light-emitting apparatus is configured to provide light at one or more intermediate levels of intensity. In some embodiments, a light-emitting apparatus may provide light in different colors, such as a lower-visibility color that does not severely impede night vision (such as red) and a higher-visibility color (such as white) so that the user can change the visibility of a high-visibility garment based on need. In some embodiments, a light-emitting apparatus provides light having intermediate-levels of visibility, such as purple, blue, green, orange, and yellow. Other configurations may also be used, such as may be desired; for example, it may be desired for emergency services personnel to have red and blue lights, optionally configured to pulse or flash, integrated into a high-visibility vest so that they can be easily identified as emergency services personnel. Other light pairings, and other controls, may also be used as desired.

According to an exemplary embodiment, a light-emitting apparatus may be coupled to a control system, which may comprise a controller. According to an exemplary embodiment, a control system may be used to manually or automatically control the operation of the light-emitting material. In some exemplary embodiments, a user may be able to control a light to provide a solid glow, a pulse in one or more frequencies (such as a slow pulse, a fast pulse, or an irregular pulse such as may be desired) or even a custom arrangement.

For example, one alternative use of a light-emitting apparatus might be for a band member, disc jockey, or other performer to configure a light-emitting apparel item, or other similar light-emitting clothing trimmings arrangement, to pulse in time with music being played. In some embodiments, the band member, disc jockey, or other performer manually inputs the tempo of the music being played using the control system to enable the light-emitting apparatus to pulse in time with the music. In other embodiments, the light-emitting apparatus and/or control system is configured to automatically determine the tempo of the music being played as is known in the art. For example, the control system may include software or otherwise be configured to interface with software capable of automatically determining the tempo of music being played.

In some exemplary embodiments, the control system may be directly operated by one or more button controls. In some embodiments, the control system may be operated based on a connection with another device (such as a near-field communication (NFC) or Bluetooth connection to a smartphone or other mobile device running a control application). In some embodiments, the control system may be operated based on any other controls such as may be desired, or may be operated by any combination of the foregoing.

In an exemplary embodiment, a light-emitting apparatus may be coupled to a sensor system. In some embodiments, the sensor system is configured to detect a change in the conditions surrounding the light-emitting apparatus. For example, the sensor system may detect when the lighting around the light-emitting diode changes. Thus in an exemplary embodiment, a light-emitting apparatus provided on safety apparel may turn on a light-emitting material, or turn a light-emitting material from a low-visibility state to a high-visibility state, when the headlights of a vehicle are detected, as the sun begins to set, when cloud coverage moves in front of the sun, or any other condition in which it may be advantageous to provide increased visibility of a person using the light-emitting apparatus. Thus in some embodiments, the light-emitting apparatus may be coupled to an optical sensor or to an array of optical sensors. In another exemplary embodiment, a light-emitting apparatus provided on safety apparel may turn on whenever a GPS receiver in a paired smartphone device (or optionally in a separate control box, on the device or on some external device like a vehicle) detects that the user of the safety apparel is on a road or within a certain distance from a road.

In some embodiments, a light-emitting apparatus may be connected to a control system in an external device with certain other automatic features. For example, safety apparel intended for a highway patrol officer may be communicatively coupled with a control system in the user's vehicle, and may be configured to come on whenever the user stops the vehicle or turns off their ignition with the vehicle's roof lights still on. This may ensure that the user's safety apparel is automatically activated before they step out their car, for example, after making a traffic stop of a vehicle. Other arrangements for sensors or for external control systems may also be understood and may be implemented as desired.

In some embodiments a light-emitting apparatus may be applied to apparel and clothing other than safety apparel, or to safety apparel not originally fitted with light-emitting clothing trimmings. According to an exemplary embodiment, a light-emitting apparatus may be provided in the form of woven tape, which may be stitched onto apparel or clothing or applied using heat and/or pressure to apparel or clothing, such as may be desired. Other forms of tape, such as polyurethane (PU) or silicone tape, may also be contemplated, and may likewise be stitched onto apparel or clothing and/or applied using heat and/or pressure to apparel or clothing. The light-emitting apparatus may be attached to apparel or clothing (such as by a separate adhesive) by any other suitable means known to those of skill in the art such as may be desired. Other forms of light-emitting apparatuses, such as badges, labels, or other fabric components, may also be contemplated and may be used as desired.

Further, in some exemplary embodiments, it may be desired to apply a more complex light-emitting apparatus to apparel or clothing, which may be configured to provide one or more images, including simple or complex messaging. According to an exemplary embodiment, a light-emitting apparatus in the form of a garment trim may be applied to an item of apparel, such as an article of clothing, and configured to display one or more images on it. In some embodiments, the light-emitting apparatus may display one or more messages across it. For example, in some exemplary embodiments, the light-emitting apparatus may take the form of a flexible screen in the shape of a tape, which may be applied to an item or apparel or a garment through heat application, through pressure application, through stitching, through any other method such as may be desired, or through any combination of the foregoing. In an exemplary embodiment, the flexible screen may be coupled to a power source and a control system used to control the messages that are displayed. For example, according to an exemplary embodiment, a flexible screen may be coupled to a combination power source and connector, which may be configured to connect to an external control system (such as a smartphone or other smart device) which may be used to control the messages that are actually displayed by the light-emitting apparatus. In an exemplary embodiment, a light-emitting apparatus may be configured to display messages in digital form, including text, symbols, and pictures and other graphics. Various behaviors of these messages, such as scrolling or pulsing, is also contemplated and may likewise be controlled by the control system.

For example, safety apparel to be worn by emergency services personnel may have integrated therewith a messaging trimming, which may be coupled to a control system. In some embodiments, the control system is an external control system of their vehicle, and may be configured to be activated when the vehicle is turned off (or otherwise, as previously discussed). The control system may be configured to display different text based on the nature of the vehicle stop, or based on user customization. For example, a police officer that has stopped a vehicle on a roadway may configure their safety apparel to display a message like “VEHICLE STOP—PLEASE KEEP TO FAR LANES,” while a police officer conducting traffic at a concert or sporting event may configure their safety apparel to provide a message like “LOT A FULL—PROCEED TO LOT B.” Other variations are possible, and may be provided by a smartphone control system, a vehicle control system, a device control system integrated into a power source, or any other control system such as may be desired. Likewise, the display of each of these messages may be customized with other message behavior, such as scrolling, pulsing, or any other text effects (or effects applied to symbols, images, and the like) such as may be desired. For example, it may be desired to provide the message “LOT A FULL—PROCEED TO LOT B→” with an arrow configured to pulse for added visibility. In another example, a user may wear clothing equipped with a message trimming as a fashion statement, rather than for a high-visibility or safety role, and may provide scrolling messages such as scrolling news ticker information simply as an attention-grabber. Other variations may also be contemplated.

In an exemplary embodiment, a light-emitting apparatus, with or without messaging, may be integrated into articles other than apparel or clothing. For example, a retractable crowd control barrier (such as are commonly used to organize lines) may be equipped with one or more messaging portions, which may, for example, be used to announce the number of a customer who will be next served or may be used to announce the estimated wait time for customers at certain positions in a line. In another exemplary embodiment, one or more articles constructed from fabric, such as furniture, may be equipped with lighting. For example, an article of furniture may be equipped with light-emitting trimmings around its perimeter, which further may be equipped with a light sensor and/or motion sensor, such that a user stumbling around in the dark is alerted to the presence of the article of furniture by activation of the light-emitting material before the user stumbles into the article of furniture. In other exemplary embodiments, any garments or any other articles than garments (including any other worn accessories such as helmets and any other personal accessories such as luggage) may be equipped with light-emitting material, such as may be desired, which may be put to various uses such as may be desired. For example, if luggage is equipped with light-emitting trimmings or messaging trimmings, the luggage may be wirelessly linked to a smartphone-based control application, such that a user can signal their luggage on a baggage conveyor and have it light up, easily identifying which article of luggage belongs to that user.

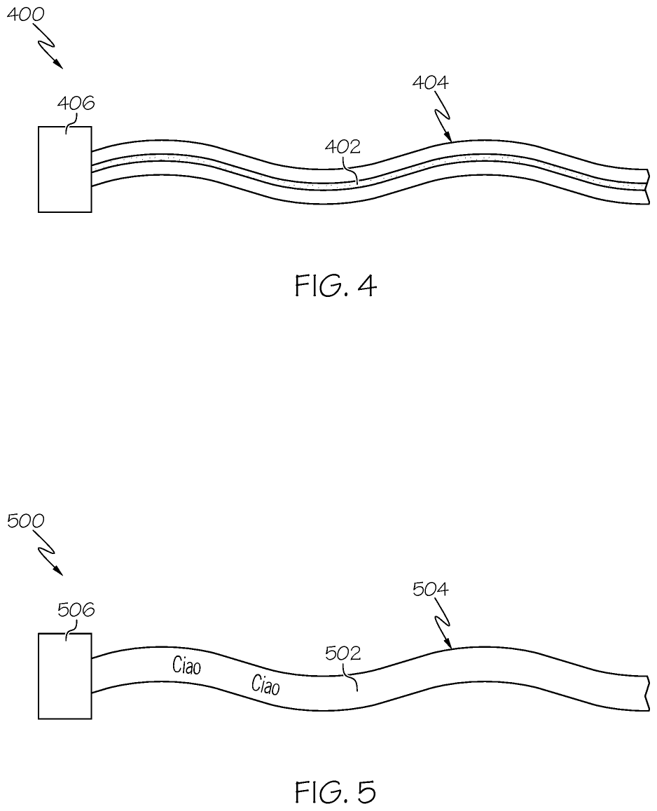

With reference to FIG. 4, FIG. 4 depicts an exemplary embodiment of a light-emitting trimming 400. According to an exemplary embodiment, a light-emitting trimming 400 may include a light-emitting material 402, including any one or more of the following materials, alone or in combination: a yarn, filament, cable (such as, but not limited to, a plastic optical fiber cable), or other similar material; a coating; a finish; a light-emitting diode; an organic-light emitting diode; or any other material capable of emitting light. Light-emitting material 402 may include a substrate 404, such as a tape, label, or insert. The light-emitting material 402 may be coupled to a power source 406, which may in some exemplary embodiments be direct or indirect such as may be desired and may in some exemplary embodiments be coupled to or integrated with a control system (not illustrated) such as may be desired.

According to an exemplary embodiment, the substrate 404 may be designed to couple to or otherwise be attached or applied to an article of clothing, for example by stitching, heat application, and/or pressure application. The substrate 404 may function to protect the light-emitting material 402, for example when the article of clothing is in the wash or exposed to harsh environmental conditions such as rain, sleet, snow, or hail. According to an exemplary embodiment, the substrate may take the form of a tape, badge, label, or other fabric component such as may be desired.

Looking next at FIG. 5, FIG. 5 depicts an exemplary embodiment of a light-emitting trimming for messaging 500. The light-emitting trimming for messaging 500 can incorporate any or all of the features disclosed elsewhere herein with respect to light-emitting trimmings. A person of ordinary skill in the art will understand that light-emitting trimming for messaging 500 must be sized, shaped, and configured to display messages or other images thereon.

According to an exemplary embodiment, a light-emitting trimming for messaging 500 may include a light-emitting material 502, including any one or more of the following materials, alone or in combination: a yarn, filament, cable (such as, but not limited to, a plastic optical fiber cable), or other similar material; a coating; a finish; a light-emitting diode; an organic-light emitting diode; or any other material capable of emitting light; and may further comprise a flexible display screen incorporating one or more of the preceding materials. In some embodiments, light-emitting material 502 may include a substrate 504, such as a tape, badge, label, insert, or other fabric component such as may be desired.

The light-emitting material 502 may be coupled to a power source 506, which may in some exemplary embodiments also function as a control unit. Alternatively, a separate control unit (not illustrated) may be coupled to the power source 506. According to an exemplary embodiment, a control unit may be coupled to a user's device, such as a user's smartphone, via a Bluetooth connection or other near-field communication (or any other type of connection such as an Internet connection such as may be desired) through which the user may control the control unit, and thus the light-emitting trimming for messaging 500. For example, in an exemplary embodiment, the user may be able to transmit text, a logo, or any other image to be displayed by the light-emitting material 502 via the combined power source and control unit 506, providing the user with an option to populate whatever text or image they may like on the light-emitting trimming 500.

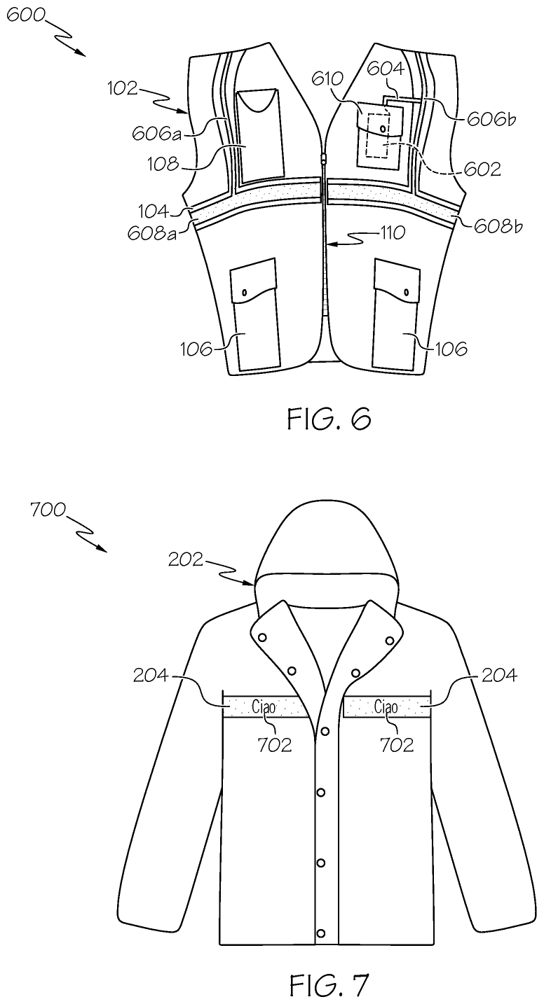

Looking next at FIG. 6, FIG. 6 shows an exemplary embodiment of an apparel item 600, such as a safety apparel item, and, more specifically, a safety vest, provided with one or more light-emitting trimmings. For example, apparel item 600 may include one or more first light-emitting trimmings 606a, 606b. As illustrated, first light-emitting trimmings 606a, 606b extend vertically up the front of the apparel item to the shoulders, and may further extend over the shoulders and down at least a portion of the back of the apparel item 600 (not illustrated). In some embodiments, and as shown in FIG. 6, apparel item 600 may also include one or more second light-emitting trimmings 608a, 608b. As illustrated, second light-emitting trimmings 608a, 608b extend horizontally across the chest of apparel item 600, and in some embodiments may connect to one another on the rear side of apparel item 600 (not illustrated). In some embodiments, second light-emitting trimmings 608a, 608b may comprise one continuous light-emitting trimming element. A person of skill in the art will understand that any number of light-emitting trimmings can be used as desired, and can be arranged or configured on an item in any manner so desired. For example, in some exemplary embodiments one or more light-emitting trimmings 606, 608 is overlaid over reflective strips 104 so as to enhance the visibility of the light-emitting trimmings 606, 608, such as may be desired. In an exemplary embodiment, any one or more light-emitting trimmings 606, 608 may be a light-emitting messaging trimming, if desired. For example, light-emitting trimmings on the rear of the reflective vest 600 (not illustrated) may be messaging trimmings, such as is desired.

According to an exemplary embodiment, an apparel item 600 having one or more light-emitting trimmings 606, 608 may have a power source 602. For reference, power source 602 is indicated by dashed lines and may be contained within a pocket of reflective vest 600, or otherwise attached to, applied to, or contained within (for example, a seam or between fabric panels) apparel item 600. In some embodiments, power source 602 is further configured to function as a control unit. Alternatively, a separate control unit (not illustrated) is coupled, either directly or indirectly, to power source 602. The power source 602 may be coupled by an electrical connection 604 to one or more light-emitting trimmings 606, 608. Power source 602 may be coupled to one or more light-emitting trimmings 606, 608 by any other means, including directly and indirectly, known to a person of ordinary skill in the art.

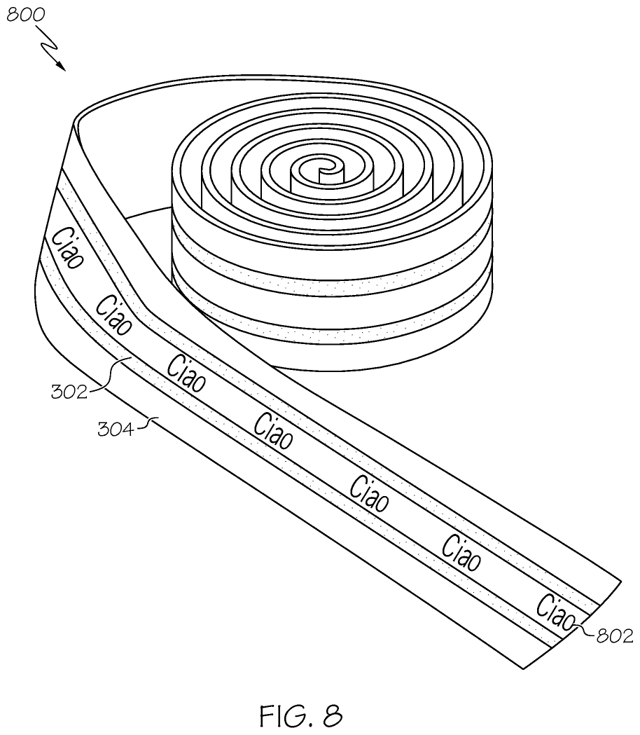

Looking next at FIG. 7, FIG. 7 depicts an exemplary embodiment of a light-emitting-trimming-fitted article 700. In some embodiments, light-emitting-trimming-fitted article 700 is a consumer article 202. For example, light-emitting-trimming-fitted article 700 may be an apparel item, such as an article of clothing. As illustrated, light-emitting-trimming-fitted article 700 is a jacket; however, light-emitting-trimming-fitted article 700 can be any other type of apparel or clothing item, including vests, sweaters or sweatshirts, tops and shirts, pants, shorts, overalls, jumpsuits, snowsuits, parkas, head ware, footwear that has been fitted with one or more light-emitting trimmings 702.

As illustrated in FIG. 7, light-emitting trimmings 702 may comprise light-emitting messaging trimmings. In some embodiments, light-emitting trimmings may be overlaid over reflectors 204 or reflective tape on consumer article 202. According to an exemplary embodiment, the one or more light-emitting trimmings 702 may be controlled by a control unit (not illustrated) coupled to a power source (not illustrated). In some embodiments, the control unit is integrated with a power source. Alternatively, the control unit is a separate element from the power source. The control unit is configured to control the light-emitting trimmings 702 based on control logic provided by a user device, such as a smartphone or other mobile device. For example, in the depicted exemplary embodiment, the user has controlled the system to display the message “Ciao,” and has provided the message in such a manner that the text of the message produces a visible wave effect. Other messages and message effects may of course be contemplated and implemented with each of the embodiments disclosed herein.

Looking next at FIG. 8, FIG. 8 depicts an exemplary embodiment of a light-emitting-trimming-fitted fabric barrier 800, which may, for example, have a light-emitting trimming 802. As illustrated, light-emitting trimming 802 can be a light-emitting messaging trimming 802. In some embodiments, and as further illustrated, light-emitting trimming 802 may be provided on a reflective portion 302, such as a reflective strip or tape. According to an exemplary embodiment, a light-emitting trimming 802 may be provided on only a portion of the reflective portion 302. In some embodiments, the light-emitting trimming 802 may be provided on only a portion of the reflective portion 302, or substantially all of the reflective portion 302, but is activated only on a portion of the reflective portion 302. For example, the activated portion of the light-emitting trimming 802 may correspond to a portion of the fabric barrier 800 that has been unrolled. This may ensure that an extensible fabric barrier 800 does not waste power providing messages over a portion of the fabric barrier 800 that has not been unrolled and which may be, for example, inside a support pillar.

In an exemplary embodiment, a fabric barrier 800 may be connected to a control system (not illustrated), which may govern all or a portion of the fabric barrier 800 over which a message is displayed (if the light-emitting trimming 802 is a light-emitting messaging trimming and if a message is to be displayed). In some embodiments, a control system provides any other messaging or light control effects such as pulsing effects, changing light color, changing light intensity, or any other effects disclosed or contemplated herein, should any be desired.

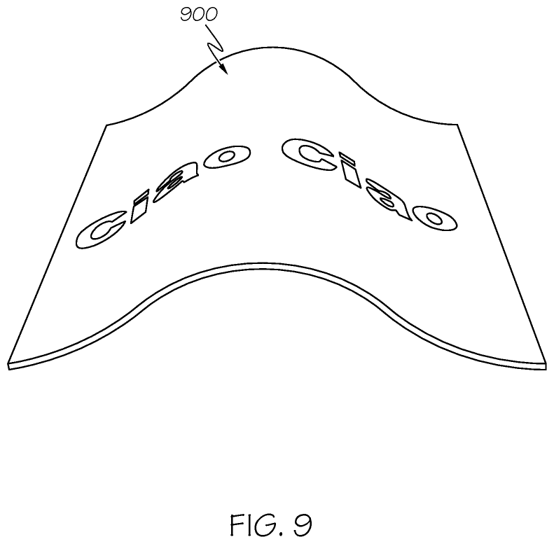

Looking next at FIG. 9, FIG. 9 provides an exemplary embodiment of a flexible display 900, which may demonstrate another application of highly flexible screen technology such as might be applied in a messaging trimming. As shown, a flexible display 900 may be a flexible screen that can sustain significant bending without any loss of functionality. Flexible display 900 may be provided in any size, shape, or configuration, as may be desired for a particular application or use in connection with the light-emitting trimmings disclosed and contemplated herein.

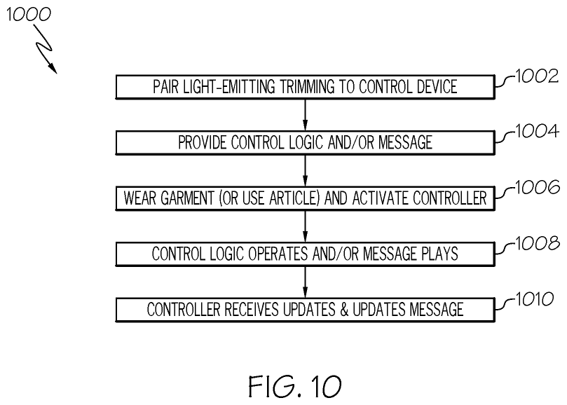

Looking next at FIG. 10, FIG. 10 provides an exemplary embodiment of a method of using a light-emitting-trimming-fitted article 1000. In a first step, a light-emitting trimming may be coupled to a control device 1002, which may be an external device or an internal device integrated with a power source. According to an exemplary embodiment, an external control device may be a smartphone or other mobile device that may be coupled to a power source of the light-emitting-trimming-fitted article 1000. An external control device may be coupled directly (such as through a wired connection) or indirectly (such as through any known wireless connection) to the power source.

In some embodiments, the control device provides control logic (e.g., pulse at 0.5 Hz, emit red colored light, alternate light intensity, etc.) and/or an image or message 1004 (e.g., display the message “Ciao”, display the cringe face emoji or other favorite emoji or image). Any other control logic or messages may be provided as may be desired. In some embodiments, the light-emitting-trimming-fitted article is an apparel item or garment, which may be worn or used by the user. As desired, the user may activate the controller 1006.

In an exemplary embodiment, a power source may include memory such that power source may retain control instructions previously provided by control device and stored thereupon. Thus, in some embodiments, power source can initiate those instructions, or one of a selection of instructions, when activated even if not connected to control device. The control logic may then operate, and/or the message may be displayed 1008. In an exemplary embodiment, the controller may provide updates, such as live updates, to the message or to the control logic, such as may be desired, based on the controller receiving said updates 1010. For example, in an exemplary embodiment where a crowd control barrier shows a “now serving” number, the controller may receive updates regarding which number should be displayed and may then display that number.

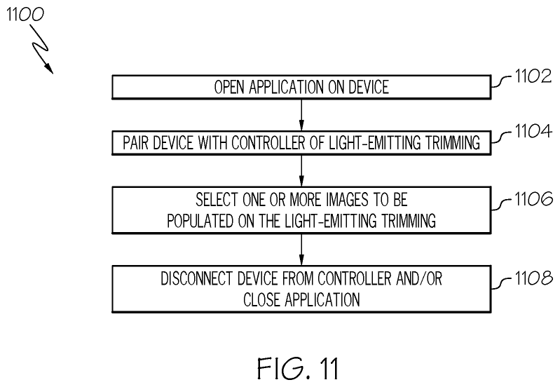

FIG. 11 illustrates a flow chart providing an alternate method 1100 for using a light-emitting apparatus, such as light-emitting trimming used to display one or more images. Beginning at step 1102, a user opens an application on a device. In some embodiments, the device may be a smartphone or other mobile device. Next, at 1104, the user pairs the device with a controller of a light-emitting trimming attached to an article. In some embodiments, the article may be any item of apparel or clothing, however other consumer articles can be used with light-emitting trimming. After pairing the device with light-emitting trimming, the user then selects one or more images in the application that the user wants to be populated or displayed on the light-emitting trimming at step 1106. In some embodiments, the one or more images include a message comprised of alphanumeric characters and/or any other visual image. Although the flow chart in FIG. 11 indicates that a user may pair the device with the controller of the light-emitting trimming prior to selecting the desired one or more images, the user may also select the one or more images before the device has been paired with the light-emitting trimming.

In some embodiments, the application is configured to allow a user to pre-select a specific date/and or time at which a selected image and/or message is to be displayed, turned off, or otherwise changed. Thus, a user may program the controller to populate one or more images and/or messages on the light-emitting trimming at a specified time in the future, or the user may program the controller to populate one or more updated images and/or messages on the light-emitting trimming at a specified time. In some embodiments, the updated image and/or message is an entirely different image and/or message. In other embodiments, the updated image and/or message may contain all or a portion of a previously selected image and/or message that has been modified in some other way. For example, a previously selected image and/or message may be updated to change color, change light intensity at which it is displayed, change other visual effect (such as a scrolling effect, flashing effect, waving effect, or other), or be updated in any other manner known to those of skill in the art.

In some embodiments, at step 1108, a user may disconnect the device from the controller of the light-emitting trimming, and/or close the application on the device. In some embodiments, the controller of the light-emitting trimming contains memory to store control logic and/or instructions so that it may automatically update an image and/or message according to a user's preference even if the device is not paired with the controller and/or the application is not open on the user's device.

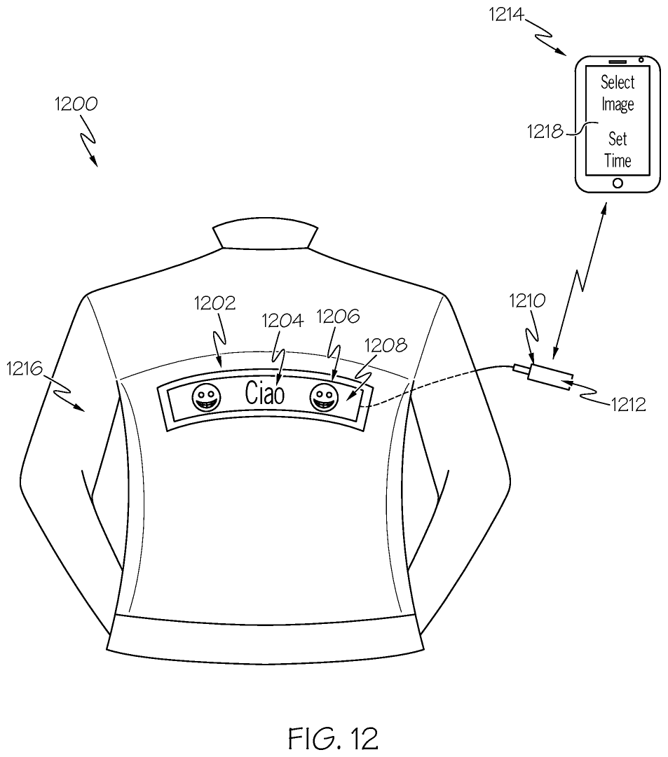

FIG. 12 illustrates a system 1200 for using a light-emitting apparatus 1202. In some embodiments, the system may be used to populate one or more images 1204 on a light-emitting apparatus 1202. For example, the system may include a trimming 1206, a light-emitting material 1208, a power source 1210, a controller 1212, and a device 1214. As illustrated, trimming 1206 comprises light-emitting material 1208, which may be in any form as disclosed herein, and may be attached to an article, such as an apparel item 1216. In operation, power source 1210 provides power to the light-emitting material 1208. As shown, power source 1210 may be directly connected to light-emitting material 1208 for powering the light-emitting material 1208. Alternatively, power source 1210 may be indirectly connected (not illustrated) to light-emitting material 1208 for powering the light-emitting material 1208.

The controller 1212 is coupled to the power source 1210 and contains control logic capable of controlling the light-emitting material 1208 to populate one or more images 1204 on the light-emitting apparatus 1202. As shown, the controller 1212 may be integrated with the power source 1210. Alternatively, the controller 1212 may be separate from the power source 1210 (not illustrated) and either connected directly or indirectly therewith. As illustrated, controller 1212 couples with a device 1214, such as a smartphone or other mobile device. In some embodiments, device 1214 has an application 1218 configured to allow a user to select one or more images 1204 to be populated on the light-emitting apparatus 1202. In some embodiments, the application 1218 is configured to allow a user to pre-select a specific date/and or time at which the one or more images 1204 is to be displayed, turned off, or otherwise changed. The one or more images 1204 may be changed in any of the manners disclosed herein or contemplated by a person of ordinary skill in the art.

In some embodiments, a separate device 1214 may not be required for a user to select one or more images 1204 to be displayed on the light-emitting apparatus 1202. Rather, the controller 1212, whether integrated with power source 1210 or separate therefrom, may have buttons, an interface, or other features (not illustrated) that enable a user to select one or more images 1204, including alphanumeric characters, to be displayed on light-emitting apparatus 1202.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A light-emitting apparatus, comprising:
a trimming configured to be attached to an article;
a light-emitting material; and
a power source for powering the light-emitting material.

2. The apparatus of claim 1, where the trimming is a tape, a label, or an insert.

3. The apparatus of claim 2, where the tape is a woven tape, a polyurethane tape, or a silicone tape.

4. The apparatus of claim 1, where the trimming is configured to be stitched to the article.

5. The apparatus of claim 4, further comprising an edge portion disposed along at least one edge of the trimming.

6. The apparatus of claim 1, where the trimming is configured to be applied to the article using heat and/or pressure.

7. The apparatus of claim 6, further comprising an adhesive backing disposed along at least a portion of a back side of the trimming.

8. The apparatus of claim 1, where the light-emitting material comprises one or more threads of light-emitting material, a tape of light-emitting material, one or more light-emitting diodes, or one or more organic light-emitting diodes.

9. The apparatus of claim 1, where the power source is a direct power source.

10. The apparatus of claim 9, where the power source comprises a battery.

11. The apparatus of claim 10, where the battery is a flexible battery.

12. The apparatus of claim 10, where the battery is a washable battery.

13. The apparatus of claim 1, where the power source comprises radio-frequency identification (RFID) technology configured to transmit power.

14. The apparatus of claim 13, where the RFID technology comprises near-field communication (NFC) technology.

15. The apparatus of claim 1, further comprising a controller configured to populate one or more images on the light-emitting apparatus.

16. The apparatus of claim 15, where the one or more images comprise one or more alphanumeric characters.

17. The apparatus of claim 15, where the controller is further configured to connect the light-emitting apparatus to a control device so that a user can select one or more images to be populated on the light-emitting apparatus.

18. A system for a light-emitting apparatus, comprising:
a trimming;
a light-emitting material;
a power source for powering the light-emitting material;
a controller coupled to the power source and containing control logic capable of controlling the light-emitting material to emit light and/or populate one or more images on the light-emitting apparatus; and
a device capable of coupling with the controller and having an application configured to allow a user to select a light to be emitted and/or the one or more images to be populated on the light-emitting apparatus.

19. A method for populating one or more images on a light-emitting apparatus, comprising:
opening an application on a smartphone;
pairing the smartphone with a controller of a light-emitting trimming attached to an article;
selecting one or more images, via the application, to be populated on the light-emitting trimming.

20. The method of claim 19, further comprising programming, via the application, the controller to populate an updated image on the light-emitting trimming at a specified time.
